(19) United States
(12) Patent Application Publication
(10) Pub. No.: US 2005/0062712 A1
(43) Pub. Date: Mar. 24, 2005

(54) Liquid crystal display device and method of controlling display

(76) Inventor: Yukihiko Noda, Okazaki-city (JP)

Correspondence Address: POSZ & BETHARDS, PLC, 11250 ROGER BACON DRIVE, SUITE 10, RESTON, VA, 20190, US

(21) Appl. No.: 10/929,775

(22) Filed: Aug. 31, 2004

(30) Foreign Application Priority Data
Sep. 2, 2003 (JP) 2003-310505

(51) Int. Cl. G09G 3/36

(52) U.S. Cl. 345/101; 345/87

(57) ABSTRACT

A liquid crystal display device has a liquid crystal display panel, a memory and a display control circuit. The memory memorizes display data. The control circuit sets, in accordance with the temperature of the display panel, the number of times of repetitively outputting each display data to the display panel. The control circuit reads out the same display data from the memory at every predetermined period repetitively to attain reading out and outputting the same display data the number of times set in accordance with the temperature of the display panel. The number of times is increased as the temperature of the display panel decreases. The number of times is further varied with a content of the display data.

### CROSS REFERENCE TO RELATED APPLICATION

This application is based on and incorporates herein by reference Japanese Patent Application No. 2003-310505 filed Sep. 2, 2003.

### FIELD OF THE INVENTION

The present invention relates to a liquid crystal display device and a method of controlling display of images on a liquid crystal display panel.

### BACKGROUND OF THE INVENTION

In a field sequential type liquid crystal display device, it has been proposed by JP-2002-365611A to change the frequency (period) of application of an image signal to a liquid crystal display (LCD) panel and activation of a backlight for the LCD panel based on a temperature of the display panel. Specifically, when the LCD panel temperature is low, the frequency of application of the image signal is set low, that is, a period of reading out an image signal for one field (screen) from a V-RAM and applying the same to X and Y electrodes of the LCD panel is set low than normal. Thus, switching the display image on the LCD panel is made less frequently than normal under low temperature conditions. The period for activating the back light is also changed in accordance with the temperature of the LCD panel. This device, however, requires additional hardware circuits for the above control.

### SUMMARY OF THE INVENTION

It is therefore an object of the present invention to provide an improved liquid crystal display device, which provides high quality display images without requiring hardware circuits for attaining a temperature-dependent image display control.

According to the present invention, a liquid crystal display device has a liquid crystal display panel, a memory and a display control circuit. The memory memorizes display data. The control circuit sets, in accordance with the temperature of the display panel, the number of times of repetitively outputting each display data to the display panel. The control circuit reads out the same display data from the memory at every predetermined period repetitively to attain reading out and outputting the same display data the number of times set in accordance with the temperature of the display panel.

Preferably, the number of times is increased as the temperature of the display panel decreases. The number of times is further varied with a content of the display data.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a liquid crystal display device according to an embodiment of the present invention;

FIG. 2 is a schematic diagram showing memory areas of a memory used in the embodiment;

FIGS. 3A to 3C are schematic diagrams showing various shutter control operations in the embodiment and in the prior art;

FIG. 4 is a flow diagram showing display control processing in the embodiment;

FIG. 5 is a schematic diagram showing a relation between a liquid crystal display panel temperature and a shutter response period in the embodiment;

FIG. 6 is a schematic diagram showing an equivalent circuit of each pixel of a liquid crystal display panel used in the embodiment; and

FIG. 7 is a flow diagram showing display control processing in a modification of the embodiment.

### DETAILED DESCRIPTION OF THE PREFERRED EMBODIMENT

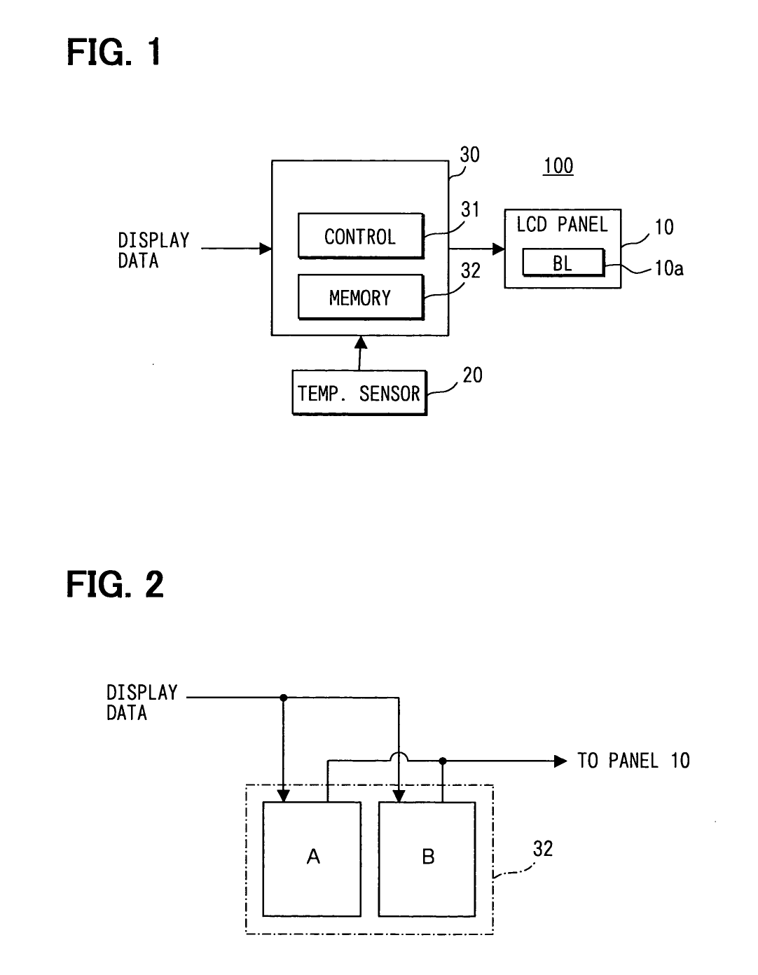

Referring first to FIG. 1, a liquid crystal display device 100 is constructed with a liquid crystal display panel (LCD panel) 10, a temperature sensor 20 and a control circuit 30. The LCD panel 10 is a display monitor. It is constructed with a thin film transistor liquid crystal display (TFT-LCD), a backlight 10a, a light conductive plate and the like. The temperature sensor 20 may detect a temperature of the LCD panel 10 directly or indirectly from surroundings of the LCD panel 10 by a thermistor.

The control circuit 30 has a control section 31 and a memory section 32. The control section 31 receives image signals (display data) from an external device and stores the same in the memory section 32. The control section 31 reads out the stored data every predetermined time period (at predetermined frequency) for each display screen or frame (field) from the memory section 32 and applies the same to the LCD panel 10. The control section 31 also controls the backlight 10a.

As shown in FIG. 2, the memory section 32 is divided into two memory areas A and B, so that the display data from the external device are alternately stored in the memory areas A and B. The control section 31 stores the display data for each field in sequence from the head address to the end address in each memory area of the memory section 32. The control section 31 further reads out the stored data alternately from the memory areas A and B in the order of storing. Thus, display data storing and reading out operations can be attained efficiently.

In the LCD panel 10, as shown in FIG. 6, when an active switch device (thin film transistor) SW is turned on to close a current supply path, electric charge of a predetermined amount is stored in a capacitor 40. Each liquid crystal 50 arranged between a pair of glass substrates with transparent electrodes and the like changes its inclination to change the amount of transmission of light 60 from the backlight 10a in accordance with an electric field applied thereto. Since the electric field varies with a voltage (stored electric charge) of the capacitor 40, the transmittance of light is changed by the voltage of the capacitor 40. As a result, color tone is controlled. After the electric charge has been stored in the capacitor 40, the active switch device SW is turned off to open the current supply path. The stored charge in the capacitor 40 is held until the next field display.

Each liquid crystal 50 thus operates as a shutter for controlling the transmission of the light 60. The LCD device 100 in this embodiment is a field sequential type. The shutter condition is changed every time the field is changed, that is, every time an image signal is applied. Since the liquid crystal 50 quickly changes its inclination in response to changes in the applied electric field under normal temperatures, a moving image can be displayed on the LCD panel 10 under such temperature conditions. The liquid crystal 50, however, changes its inclination only slowly under low temperatures, for instance below 0° C. Due to this slow response characteristic, the moving image display quality is lowered under such low temperature conditions.

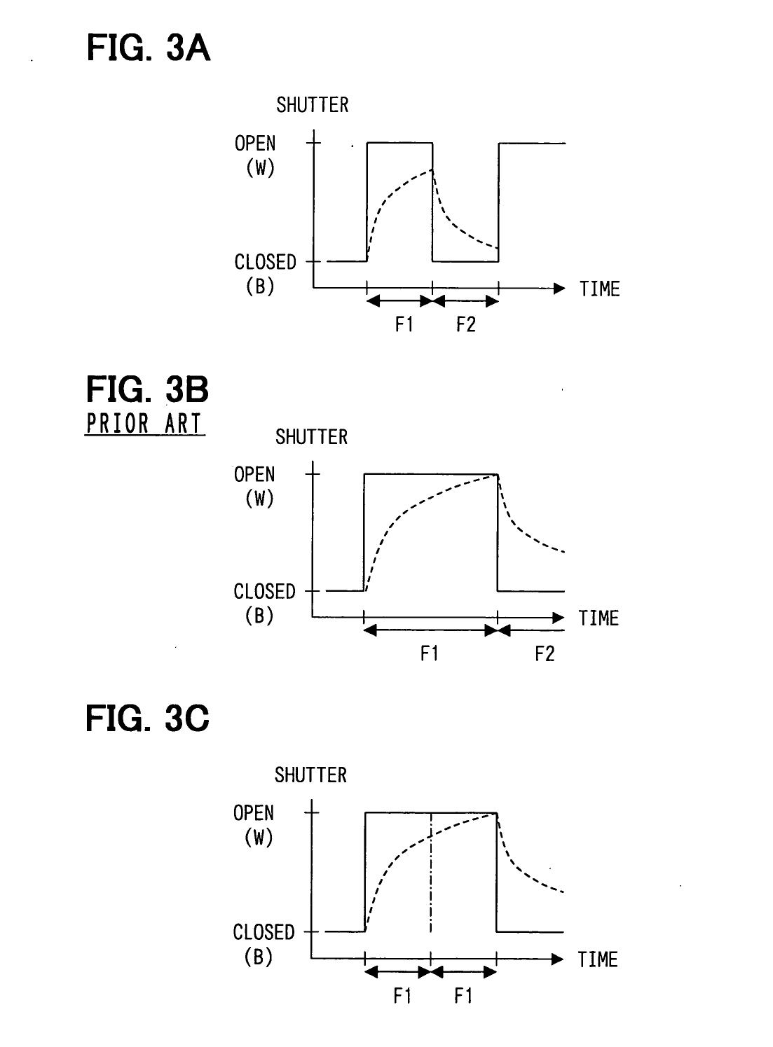

A TN liquid crystal, which provides normally white color under no electric field condition, provides different shutter operations depending on temperatures. Specifically, as shown by a solid line in FIG. 3A, the liquid crystal quickly changes its inclination between a desired open position for providing a white color (W) and a desired closed position for providing a black color (B) at every change of fields, for instance between F1 and F2, under normal temperature conditions.

The liquid crystal, however, changes its position only slowly under low temperature conditions. As a result, as shown by a dotted line in FIG. 3A, the liquid crystal cannot attain the desired open position and the desired closed position within the time period of each field F1, F2. Due to this slow response characteristic under low temperature conditions, the liquid crystal cannot completely close the light path even when a black color is to be presented for a field F2. Thus, a part of the light from the backlight passes through the liquid crystal. As a result, the color of display image is changed from white to black only gradually.

According to JP-2002-365611A, the time period for each field F1, F2 is extended to fully open and close the light path under low temperature conditions as shown in FIG. 3B. It is to be noted in the LCD panel 10 shown in FIG. 6, however, that the electric charge in the capacitor 40 starts to gradually leak after the active switch device SW is turned off. Thus, if the capacitor voltage changes, the color tone is degraded. Therefore, the period (frequency) of applying the image signal, that is, period of display of each field cannot be extended in excess of a period for which the capacitor 40 can hold the electric charge.

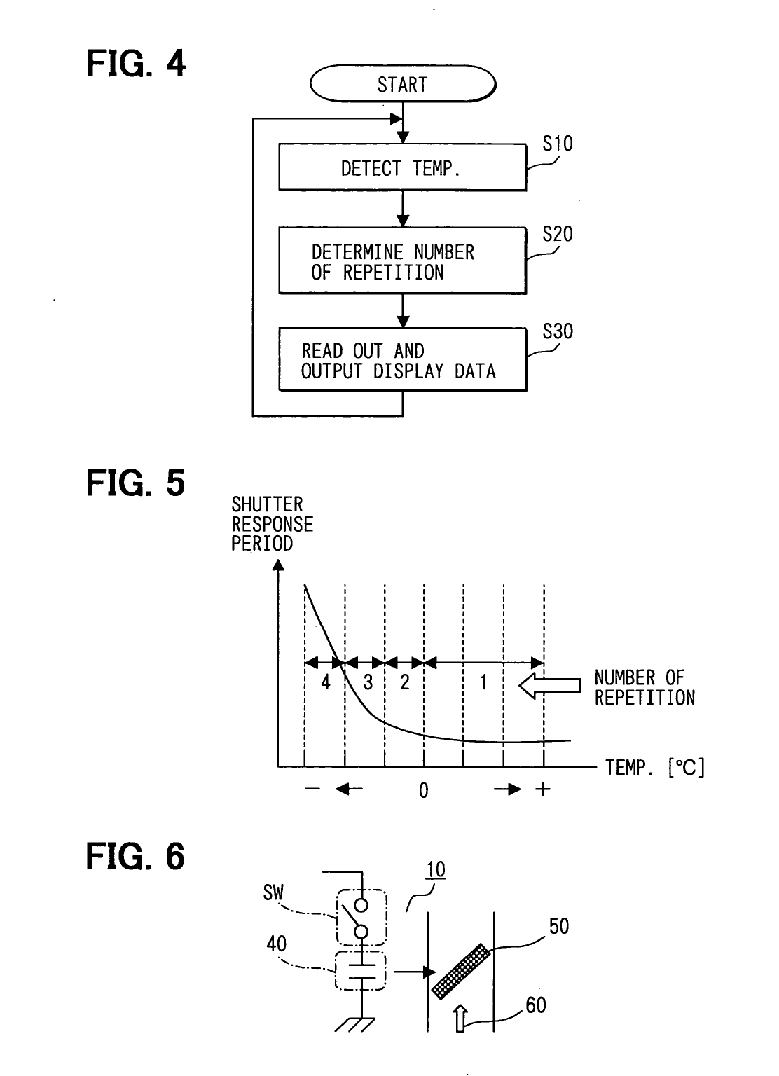

The liquid crystal display device 100 according to the embodiment therefore repetitively applies the same image signal to the LCD panel 10a for each field as shown in FIG. 3C. For this control, the control circuit 30 (particularly control section 31) is programmed to execute display control processing shown in FIG. 4.

In the display control processing shown in FIG. 4, a temperature of the LCD panel 10 is detected from an output of the temperature sensor 20 at step S10. Then, the number of applications of the image signal for each field, that is, the period of repetitively reading out from the memory section 32 and outputting to the LCD panel 10 the same display data, is determined based on the detected temperature.

This number of repetition may be determined from a predetermined relation between a temperature and a shutter response period of the liquid crystal as shown in FIG. 5. This relation may be determined empirically and stored for reference at step S20. The number of repetition is increased as the detected temperature decreases.

The display data for each field is read out from the memory section 32 and output to the LCD panel 10 a number of times determined at step S20. If the reading out and outputting the display data is attained at a frequency of 60 Hz and only once for each field, display data for 60 fields are read out from the memory section 32 in one second and outputted to the LCD panel 10 as sixty different image signals for moving images. The display data are read out from the memory areas A and B alternately, that is, in the sequence of A, B, A and so on.

If the number of repetition is determined to two, the same display data is read out from the memory area A or B of the memory section twice and output to the LCD display 10 twice. Thus, in this instance, the display data are read out from memory areas in the sequence of A, A, B, B, A, A and so on. As a result, as shown in FIG. 3C, the display data reading out and outputting is attained at the same frequency (60 Hz), but the period of displaying the same image is extended in effect.

The active switch device SW is driven a plural number of times and accordingly the capacitor 40 is charged the same number of times, if the number of repetition is determined to two or more. In this instance, the capacitor 40 is charged at the same period irrespective of the determined number of repetition of outputting the same display data. Therefore, since leaking of the electric charge in the capacitor can be made negligible, high quality image display can be provided even under low temperature conditions. Thus, the frequency of changing the display image on the LCD panel 10 is lowered in effect.

According to the embodiment, the LCD panel 10, specifically the active switch device SW, can be controlled based on the detected temperatures by the software processing without adding hardware circuits for changing the frequency of changing the display image based on the detected temperatures. Further, even if operation characteristic of LCD panel varies from unit to unit or from manufacturer to manufacturer, the display control characteristics can be adapted to each type of LCD panel with ease by modifying the control software of the control section 31.

The above embodiment may be modified in various ways.

For instance, the frequency of changing the display data may also be changed in accordance with display content. In the case that the display device 100 is used in a navigation system for a vehicle, it is not so necessary to change adisplay image so frequently because the display content (road map, etc.) does not change so much in a short time. Therefore, the frequency of changing the display image need not be changed based on temperature conditions.

In the case that the display device 100 is used to display a moving image taken by a camera, however, it is desirable to change a display image based on temperature conditions to clearly display the moving image even under the low temperature condition.

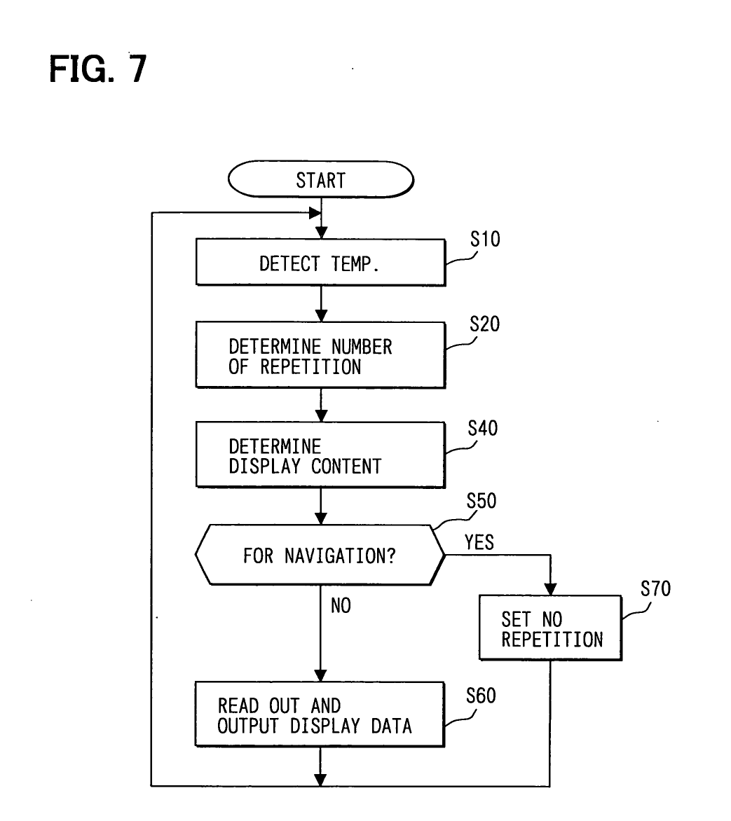

Processing for this content-dependent display control is attained by software as shown in FIG. 7. In this processing, steps S40 to S70 are executed following step S20 in the above embodiment (FIG. 4).

Specifically, display content is determined at step S40 by checking, for instance, a device which supplies the display data, nature of the display data, desired speed of movement of the display image on the LCD panel 10. Then, it is determined at step S50 whether the display image is for navigation or for similar type, which is not required to move fast on the LCD panel 10.

If the display data is not for the navigation or the like, the same display data is read out and output repetitively at step S60 by a plural number of times as determined at step S20. It is to be noted that, when the number of repetition reaches the number of repetition determined at step S20, the display data to be read out and outputted is changed from the area A to the area B or from the area B to the area A as in the above embodiment. If the display data is for navigation or the like, the number of repetition determined at step S20 is changed to one at step S70, that is, no repetition is set. At step S70, it is of course possible to reduce the number of repetition set at step S20 to a value larger than one as the case may be. Thus, at step S70, the same display data is read out from the memory section 32 and outputted to the LCD panel 10 in the similar manner but less number of times from the number of reading out and outputting at step S60.

Further modifications and changes are also possible without departing from the spirit of the invention.

1. A liquid crystal display device comprising:
display means including a liquid crystal display panel;
memory means for memorizing a plurality of display data, which is to be outputted to the display means;
temperature detecting means for detecting a temperature of the display means or a surrounding of the same;
repetition setting means for setting, in accordance with the temperature detected by the temperature detecting means, a number of times of repetitively outputting each of the plurality of display data to the display means; and
display control means for storing the plurality of display data into the memory means, reading out the plurality of display data from the memory means and outputting the plurality of display data to the display means,
wherein the display control means repeats at every predetermined period an operation of reading out and outputting each of the plurality of display data the number of times set by the repetition setting means.

2. The liquid crystal display device as in claim 1, wherein:
the memory means is divided into a plurality of areas; and
the display control means stores the plurality of display data in the plurality of areas in sequence and reads out the plurality of display data from the plurality of areas in a predetermined order in which the plurality of display data has been stored.

3. The liquid crystal display device as in claim 1, wherein the repetition setting means varies the number of times in accordance with a content of the plurality of display data.

4. The liquid crystal display device as in claim 3, wherein the repetition setting means sets the number of times to a smaller value in a case that the plurality of display data is vehicle navigation data than in a case that the plurality of display data is other than the vehicle navigation data.

5. The liquid crystal display device as in claim 1, wherein the repetition setting means sets the number of times to a larger value as the temperature of the display means or the surrounding of the same becomes lower.

6. A display control method comprising steps of:
memorizing in a memory a plurality of display data, which is to be outputted to a display device including a liquid crystal display panel;
detecting a temperature of the display panel or a surrounding of the same;
setting, in accordance with the temperature of the display panel, a number of times of repetitively outputting each of the plurality of display data to the display device;
reading out the plurality of display data from the memory and outputting the plurality of display data to the display device; and
repeating, at every predetermined period, a step of reading out and outputting each of the plurality of display data the number of times set by the setting step.

7. The display device control method as in claim 6, wherein:
the memorizing step memorizes the plurality of display data in the plurality of memory areas of the memory in sequence and reads out the plurality of display data from the plurality of memory areas in a predetermined order in which the plurality of display data has been stored.

8. The display device control method as in claim 6, further comprising a step of:
varying the number of times in accordance with a content of the plurality of display data.

9. The display device control method as in claim 8, wherein the varying step varies the number of times to a smaller value in a case that the plurality of display data is vehicle navigation data than in a case that the plurality of display data is other than the vehicle navigation data.

10. The display device control method as in claim 6, wherein the setting step sets the number of times to a larger value as the temperature of the display panel becomes lower.

11. The display device control method as in claim 6, further comprising a step of:
determining a content of the plurality of display data in accordance with a required speed of change of the plurality of display data on the liquid crystal display panel,
wherein the setting step sets the number of times further in accordance with the content of the plurality of display data.
